(19) United States
(12) Patent Application Publication
(10) Pub. No.: US 2005/0210305 A1
(43) Pub. Date: Sep. 22, 2005

(54) Data processor for controlling voltage supplied for processing

(75) Inventor: Seiichiro Kihara, Katsuragi-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/084,108

(22) Filed: Mar. 21, 2005

(30) Foreign Application Priority Data
Mar. 22, 2004 (JP) 2004-082290
Nov. 24, 2004 (JP) 2004-338998

(51) Int. Cl. G06F 1/26

(52) U.S. Cl. 713/322; 713/300

(57) ABSTRACT

In a data processor, each logic circuit receives data provided from the transfer control unit being connected, processes the data, and outputs the data to the transfer control unit in the next stage. The data processing speed is changed in accordance with the level of a voltage supplied to the logic circuit. Each transfer control unit includes a plurality of C elements receiving a request pulse for data transfer provided from the preceding stage and transferring the same to the next stage, a plurality of pipeline registers, and a plurality of P circuits. Each pipeline register, in response to every reception of the request pulse, receives, holds and outputs the data requested to be transferred. Each P circuit determines frequency of data supply to the logic circuit being connected, and controls the level of a voltage supplied to the logic circuit in accordance with the determined frequency.

This nonprovisional application is based on Japanese Patent Applications Nos. 2004-082290 and 2004-338998 filed with the Japan Patent Office on Mar. 22, 2004 and Nov. 24, 2004, respectively, the entire contents of which are hereby incorporated by reference.

### BACKGROUND OF THE INVENTION

1. Field of the Invention

The present invention relates to a data processor, and particularly, to a data processor that can control, when processing data while transferring it, a voltage supplied for the processing.

2. Description of the Background Art

Conventionally, for example a microcomputer configured by a clock synchronous type logic circuit disclosed in Japanese Patent Laying-Open No. 05-324867 includes a clock control device for reducing the clock frequency and a power source control unit controlling the power source voltage based on control signals output from CPU (abbreviation of Central Processing Unit), peripheral devices and the like, in order to reduce power consumption.

A data-driven type logic circuit that is not the clock synchronous type is disclosed, for example, in “EDN JAPAN”, Reed Business Information Japan K.K., August 2003, pp. 61-65. The circuit disclosed in the reference autonomously stops its operation when data is not input, and therefore, has a feature of smaller power consumption as compared to a clock synchronous type logic circuit. This feature is described in the following.

FIG. 10 shows a structure of a data packet applied to the data-driven type information processor according to a conventional example and the present embodiment. A data packet 10 in FIG. 10 includes a destination node number field F1 for storing destination node number 11, a generation number field F2 for storing generation number 12, an instruction code field F3 for storing an instruction code 13, and a data field F4 for storing data 14. Generation number 12 is the number for distinguishing each group of data packets 10 processed in parallel in the data-driven type information processor. Destination node number 11 is the number used for distinguishably processing data packets 10 of an identical generation in the data-driven type information processor. By instruction code 13, the operation to be performed to information within data packet 10 in the data-driven type information processor is specified.

Referring to FIG. 11, a conventional data transfer control device 20 includes a self-synchronous type transfer control circuit (hereinafter referred to as C element) 2 and a data holding circuit (hereinafter referred to as a pipeline register) 4 consisting of D-type flipflops, being associated to each other. C element 2 has a transfer request input terminal CI receiving a transfer request signal (hereinafter referred to as SEND signal), a transfer permission output terminal RO outputting a transfer permission signal (hereinafter referred to as ACK signal) indicating permission or prohibition of transfer, a transfer request output terminal CO outputting SEND signal, a transfer permission input terminal RI receiving ACK signal, a pulse output terminal CP for providing a clock pulse controlling a data holding operation of pipeline register 4, and a master reset input terminal (not shown) for inputting a master reset signal MR that is externally provided.

Referring to FIGS. 12A-12E, an operation of C element 2 shown in FIG. 11 is described. Upon receiving SEND signal which is a pulse signal shown in FIG. 12A through transfer request input terminal CI, C element 2 outputs ACK signal which is a pulse signal shown in FIG. 12D from transfer request output terminal CO if ACK signal which is a pulse signal shown in FIG. 12E at transfer permission input terminal RI is in a permission state (level “H” state), and outputs a clock pulse shown in FIG. 12C from pulse output terminal CP to corresponding pipeline register 4.

In response to reception of the clock pulse from corresponding C element 2, pipeline register 4 receives and holds the provided data packet 10, and outputs the held data packet 10.

Thus, in the circuit shown in FIG. 11, in order to hold the data provided from the preceding stage with pipeline register 4, C element 2 outputs a clock pulse to pipeline register 4 based on a data transfer request signal (SEND signal) or a permission signal (ACK signal). Pipeline register 4 receives and holds the data requested to be transferred from the preceding stage, and outputs it.

A data processor 30 shown in FIG. 13 is configured by serially connecting a plurality of data transfer control devices 20 shown in FIG. 11 interposing prescribed logic circuits. Here, in order to simplify the description, three data transfer control devices 20 are connected. In FIG. 13, in order to distinguish three data transfer control devices 20, they are respectively referred to as data transfer control devices 20A, 20B and 20C. Data transfer control device 20A has C element 2A and pipeline register 4A, data transfer control device 20B has C element 2B and pipeline register 4B, and data transfer control device 20C has C element 2C and pipeline register 4C. Respective configurations and functions of data transfer control devices 20A, 20B and 20C are similar to those shown in FIG. 11.

In FIG. 13, data packets 10 input to data processor 30 are successively processed by logic circuits 6A and 6B that are data processing units while they are transferred through the pipeline registers in the order of pipeline register 4A→4B→4C. Here, from which data packet 10 is transferred is referred to as the preceding stage, and to which data packet 10 is transferred is referred to as the next stage.

In FIG. 13, for example, if pipeline register 4A is in a data holding state and if pipeline register 4B in the next stage is in a data holding state, data packet 10 is not transmitted from pipeline register 4A to pipeline register 4B. Additionally, if pipeline register 4B in the next stage is in a state not holding data, or enters the state not holding data, data packet 10 is transferred from pipeline register 4A to logic circuit 6A taking at least a pre-set time. Data packet 10 is processed at logic circuit 6A, and then processed data packet 10 is transferred to pipeline register 4B. Such a pre-set time is referred to as a delay time.

In FIG. 13, data packet 10 is transferred in accordance with SEND signal and ACK signal transmitted/received between adjacent data transfer control devices 20, taking at least a pre-set delay time in an asynchronous manner. Such transfer control is referred to as self-synchronous type transfer control. A circuit controlling data transfer according to self-synchronous type transfer control is referred to as a self-synchronous type transfer control circuit.

Referring to FIG. 14, a configuration of C element 2 shown in FIG. 11 is described. For example, the circuit shown in FIG. 14 is disclosed in Japanese Patent Laying-Open No. 06-083731. In FIG. 14, transfer request input terminal CI receives SEND signal which is a pulse signal from the preceding stage, and transfer permission output terminal RO outputs ACK signal to the preceding stage. Transfer request output terminal CO outputs SEND signal which is a pulse signal to the next stage, and transfer permission input terminal RI receives ACK signal from the next stage. A master reset input terminal (not shown) receives a master reset signal MR which is externally provided.

When the master reset input terminal (not shown) receives master reset signal MR which is a pulse signal at “H” level, master reset signal MR is inverted by an inverter 5F, and thereafter provided to flipflops 5A and 5B. In response to the input of master reset signal MR, flipflops 5A and 5B are reset, and consequently C element 2 is initialized. Here, transfer request output terminal CO and transfer permission output terminal RO both output a signal at “H” level indicative of an initialized state. The “H” level of the output signal from transfer permission output terminal RO indicates a transfer permission state, whereas the “L” level thereof indicates a transfer prohibition state.

The “H” level of the output signal from transfer request output terminal CO indicates a state where data transfer is not requested to the next stage, whereas the “L” level thereof indicates a state where data transfer is being requested or data is being transferred to the next stage.

When a signal of “L” level is input to transfer request input terminal CI, that is, when data transfer is requested from the preceding stage, flipflop 5A is set and outputs a signal of “H” level. As a result, the signal level of a node Q attains “H” level. This “H” level signal is inverted by an inverter 5G and provided to transfer permission output terminal RO. Accordingly, as transfer permission output terminal RO outputs a signal of “L” level, it prohibits further data transfer from the preceding stage to its own stage.

After a certain period of time has passed, a signal of “H” level is input to transfer request input terminal CI, and setting at data transfer control device 20 of data from the preceding stage to C element 2 is completed. In such a state and if a signal of “H” level is provided to transfer permission input terminal RI, that is, in a state where data transfer is permitted by the next stage, and transfer request output terminal CO outputs a signal of “H” level, that is, in a state where data is not being transferred to the next stage (data transfer is not requested to the next stage), an NAND gate 5C is activated and outputs an “L” level signal to flipflops 5A and 5B. As a result, flipflops 5A and 5B are both reset. Flipflop 5B outputs a signal at “H” level from pulse output terminal CP to pipeline register 4 through a delay element 5E, and outputs SEND signal at “L” level from transfer request output terminal CO to the C element in the next stage, which is not shown, through a delay element 5D. That is, data transfer is requested to the next stage.

The C element in the next stage, which is not shown and which has received SEND signal at “L” level, sets ACK signal indicating transfer prohibition to “L” level so as not to allow further data transfer to data transfer control device 20 to which it belongs, and outputs that ACK signal from the RO terminal to C element 2.

C element 2 receives ACK signal at “L” level through transfer permission input terminal RI, and flipflop 5B is set by that received signal. As a result, the “L” level signal is output from pulse output terminal CP to pipeline register 4, which is not shown and corresponding to C element 2, through delay element 5E, and SEND signal at “H” level is output from transfer request output terminal CO to the next stage through delay element 5D. Thus, data transfer ends.

A conventional data-driven type information processor 400 shown in FIG. 15 includes data processor 30 shown in FIG. 13. Referring to FIG. 15, data-driven type information processor 400 includes a junction unit 411, a firing control unit 421, an operation unit 431, a program storage unit 441, a branch unit 451, pipeline registers 4A to 4C, and C elements 2A to 2C. Respective ones of C elements 2A to 2C control transfer of data packets 10 to corresponding processing units, that is, to respective ones of firing control unit 421, operation unit 431 and program storage unit 441, through transmission and reception of a packet transfer pulse (input/output signals through terminals CI, CO, RI, and RO) with the C elements in the preceding and next stages.

In response to input of pulses from corresponding C elements 2A to 2C, respective ones of pipeline registers 4A to 4C receive and hold data packets 10 provided from processing units in the preceding stage, send held data packets 10 to an output stage, and hold data packets 10 until next pulse is input.

In FIG. 15, when data packet 10 is provided to data-driven type information processor 400, the provided data packet 10 first passes through junction unit 411 and is provided to firing control unit 421. When firing control unit 421 receives data packets 10 from junction unit 411, it detects two data packets 10 that are different but shares the identical destination node number 11 and generation number 12 out of input data packets 10. Then, it adds and stores data 14 of one detected data packet 10 in data field F4 of the other data packet 10, and outputs the other data packet 10 (the one data packet 10 is deleted). Data packet 10 output from firing control unit 421 is provided to operation unit 431 through pipeline register 4A. Operation unit 431 receives data packet 10 from pipeline register 4A, subjects information in received data packet 10 to a prescribed operation based on instruction code 13 of received data packet 10, and stores a result of operation in data field F4 of received data packet 10. Thereafter, input data packet 10 is provided to program storage unit 441 through pipeline register 4B.

Upon receiving data packet 10 from pipeline register 4B, program storage unit 441 reads subsequent destination node number 11 and subsequent instruction code 13 from a data flow program stored in advance in a program memory, which is not shown and which is in program storage unit 441, based on destination node number 11 of received data packet 10. Then, it stores read subsequent destination node number 11 and instruction code 13 in destination node number field F1 and instruction code field F3 of received data packet 10 respectively, and outputs received data packet 10. If a copy flag is read from the program memory, a second data packet is also generated and output.

Data packet 10 output from program storage unit 441 is provided to branch unit 451 through pipeline register 4C. Branch unit 451 either provides received data packet 10 to the outside of data-driven type information processor 400 or outputs the same to junction unit 411 (returns it to the inside of data-driven type information processor 400), based on destination node number 11 of data packet 10 received from pipeline register 4C and in accordance with a predetermined rule.

The data-driven type information processor such as described above is configured using LSI (Large Scale Integration). In LSI designing, finer design rule has been introduced due to the progress in the semiconductor manufacturing technique in recent years, which results in reduced threshold voltage of transistors. Accordingly, measures for avoiding an increase in power consumption of transistors inside LSI due to an increase in leakage current has been needed. While the application of measures of a clock synchronous type logic circuit is preferable for reducing the power consumption of the data-driven type information processor, the application has been difficult because of the following reasons.

In a clock synchronous type logic circuit, it has been proposed to reduce the power consumption by controlling clock frequencies and power source voltage. However, as the control is complicated, it has not been applicable to the case where a circuit block of which power consumption is desired to be reduced is a small block unit. Additionally, the control procedure varies depending on the environment where the apparatus including the clock synchronous type logic circuit is applied, and control procedure must be changed every time the environment is changed. Thus, general application has been difficult. Accordingly, it has been-impossible to apply the control procedure also to a data-driven type information processor having such features that it does not require an external clock and only operates when data processing is necessary.

### SUMMARY OF THE INVENTION

Accordingly, an object of the present invention is to provide a data processor that can reduce the power consumption when processing data while transferring the same in accordance with self-synchronous type transfer control.

In order to achieve the foregoing object, a data processor according to one aspect of the present invention includes transfer control units serially connected in a plurality of stages, and processing units respectively connected to the plurality of stages of transfer control units. Each processing unit receives data output from the transfer control unit being connected, processes the received data, and outputs the processed data to the transfer control unit in a next stage. The speed of data processing by the processing unit is changed in accordance with the level of the voltage supplied to the processing unit. Each transfer control unit includes a self-synchronous type transfer control unit and a voltage control unit. The self-synchronous type transfer control unit receives a request pulse for data transfer provided from a preceding stage and transferring the request pulse to a next stage based on a request signal for data transfer and a permission signal for data transfer. The voltage control unit determines frequency of data supply to the processing unit being connected, and controls the level of the voltage supplied to the processing unit in accordance with the determined frequency.

Accordingly, for each processing unit, the voltage level being supplied is controlled in accordance with the frequency of supply of data to be processed to itself, whereby the processing unit processes data at the speed in accordance with the level of the voltage being supplied. Therefore, since the processing unit is supplied with the voltage of the level suitable to the amount of data to be processed, i.e., suitable to attain the necessary processing speed, excess or shortage of voltage supply can be prevented. As a result, with the data processor, power consumption is reduced while the processing speed according to the amount of data to be processed is maintained.

Preferably, the frequency determined by the voltage control unit is the frequency of reception of the request pulse by the transfer control unit in its own stage. Accordingly, the frequency of supply of data to be processed to the processing unit can be detected by the frequency of reception of the request pulse, transferred from the preceding stage, by the transfer control unit in its own stage.

Preferably, the frequency determined by the voltage control unit is the frequency of reception of the request pulse by the transfer control unit in the preceding stage. Accordingly, by detecting the frequency of the reception of the request pulse by the preceding stage, an expected frequency of subsequent data supply to the processing unit can be detected in advance, and based on the detection result, the voltage level to be supplied can be changed in advance. Therefore, it is possible to provide a precharge period of the voltage to the processing unit, and the data processing speed of the processing unit can be quickly shifted to an appropriate speed, even when, for example, data supply is interrupted and then resumed.

Preferably, the voltage control unit includes a counter unit adding a prescribed addition value to a count value in response to every reception of the request pulse, and subtracting a prescribed subtraction value from the count value in a prescribed cycle during a period without reception of the request pulse, and a voltage select unit selectively determining the level of the voltage supplied to the processing unit based on the count value. Accordingly, the frequency of data supply to the processing unit is determined based on the count value of the counter unit.

Preferably, the voltage select unit selectively determines the level of the voltage supplied to the processing unit based on the count value of the counter unit of the transfer control unit in its own stage. Accordingly, the voltage select unit can determine the frequency of data supply to the processing unit based on the count value of the counter unit in its own stage.

Preferably, the voltage select unit selectively determines the level of the voltage supplied to the processing unit based on the count value of the counter unit of the transfer control unit in the preceding stage. Accordingly, the voltage select unit can determine the frequency of data supply to the processing unit in its own stage based on the count value of the count unit in the preceding stage.

Preferably, the voltage select unit has a compare unit comparing a count value and a prescribed value, and based on the comparison result of the compare unit, the level of the voltage to be supplied to the processing unit can be determined out of two types of levels.

Preferably, the voltage select unit has a plurality of compare units comparing the count value and respective ones of different prescribed values. Based on a plurality of comparison results of the plurality of compare units, the level of the voltage to be supplied to the processing unit is determined out of at least three types of levels. Accordingly, the frequency of supplying data to the processing unit is categorized into at least three, and the voltage of an appropriate level according to the frequency of each category is supplied to the processing unit.

Preferably, the aforementioned prescribed cycle is variably set, and therefore, even with the same supply frequency of data to the processing unit, by changing the cycle, the timing of chaining the level of the voltage supplied to the processing unit can be changed.

Preferably, the aforementioned prescribed addition value or a prescribed subtraction value is variably set. Therefore, even with the same supply frequency of data to the processing unit, by changing those values, the timing of chaining the level of the voltage supplied to the processing unit can be changed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a data processor applied to an embodiment of the present invention.

FIG. 2 shows a configuration of a data transfer control unit.

FIG. 3 shows a configuration of a P circuit.

FIGS. 4A-4E are timing charts showing state transition between a suspended state and an operation state of the data processor.

FIGS. 5A and 5B show another configuration of the P circuit and a configuration of a data transfer control unit including that P circuit.

FIG. 6 is a schematic diagram showing a configuration of a large scale processing system according to the present embodiment.

FIG. 7 shows a configuration of a data processor according to another embodiment of the present invention.

FIG. 8 shows a configuration of a data processor according to still another embodiment of the present invention.

FIG. 9 shows a configuration of a data processor according to still another embodiment of the present invention.

FIG. 10 shows a structure of a data packet according to a conventional example and the present embodiment.

FIG. 11 is a block diagram showing a configuration of a conventional data transfer control unit.

FIGS. 12A-12E are timing charts related to the description of an operation of a C element shown in FIG. 11.

FIG. 13 is a block diagram of a data processor configured by serially connecting a plurality of data transfer control units shown in FIG. 11.

FIG. 14 is a circuit diagram of the C element shown in FIG. 11.

FIG. 15 is a schematic block diagram of a conventional data-driven type information processor.

### DESCRIPTION OF THE PREFERRED EMBODIMENTS

In the data processor of the present embodiment, for each data transfer control unit, by comparing the number of data packets per unit time supplied to a corresponding logic circuit to be processed and a value pre-set to a register, the voltage level corresponding to an operation state to which the logic circuit should transit is determined, and a voltage at that determined level is supplied to the logic circuit. This is described in the following.

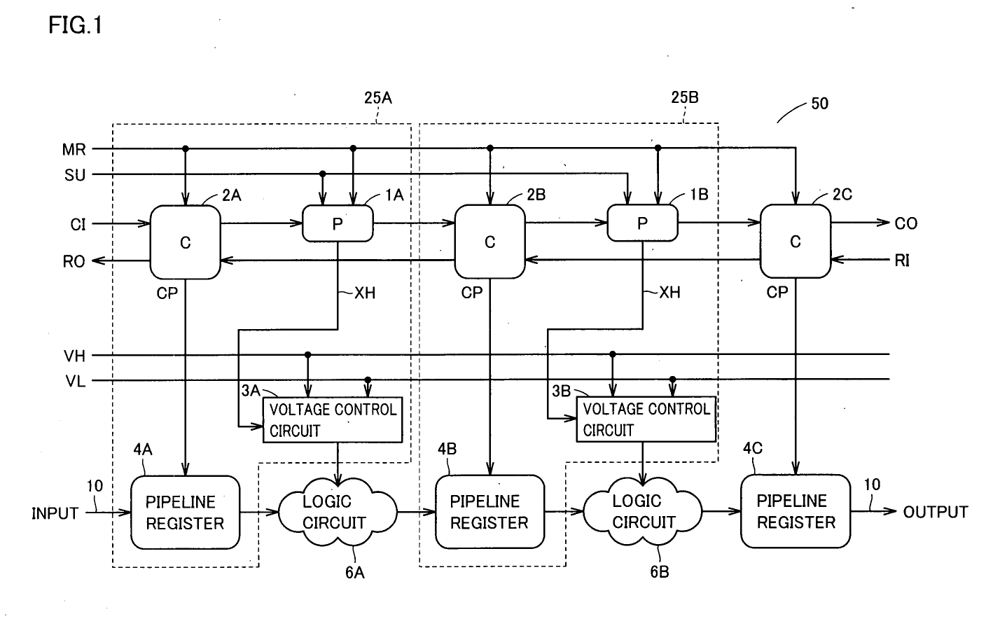

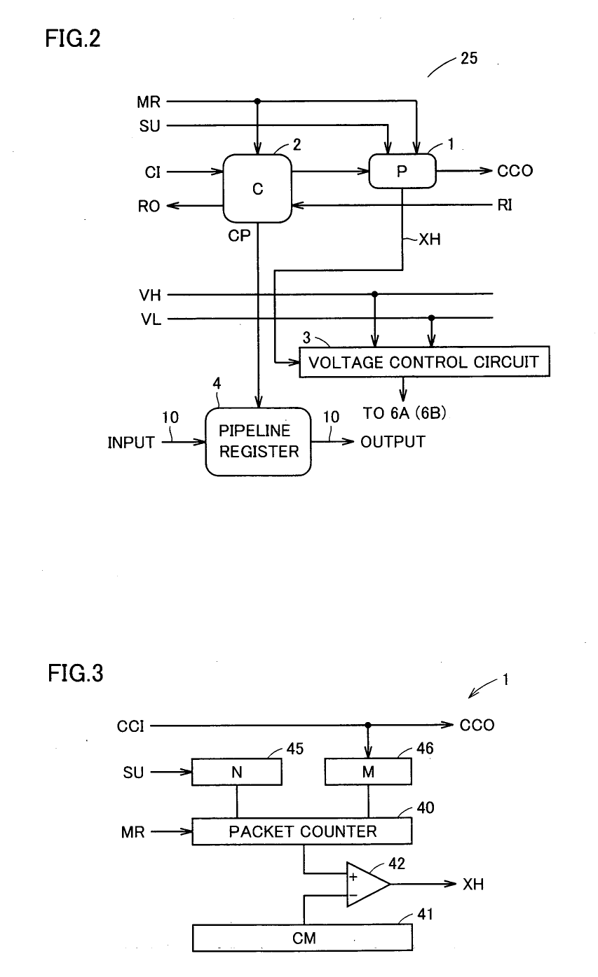

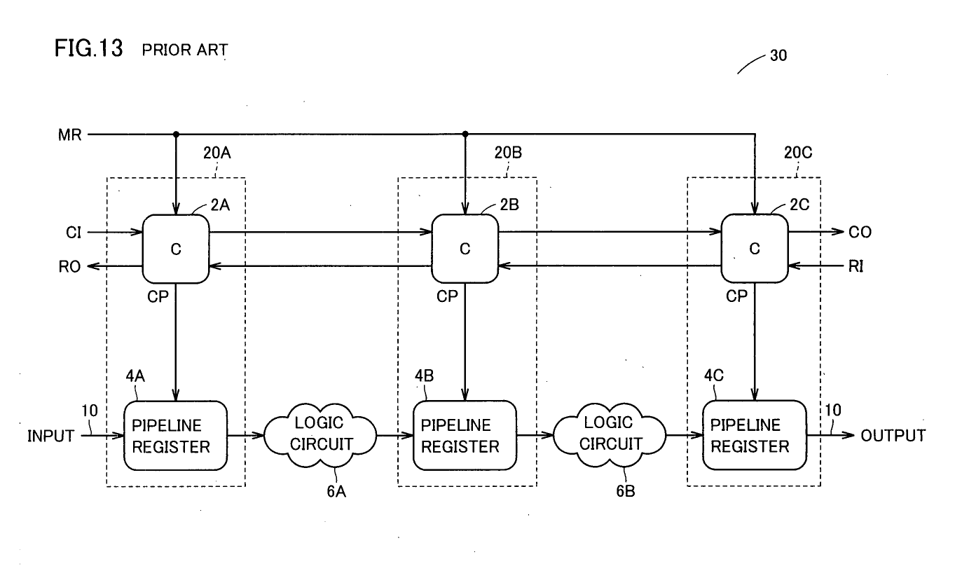

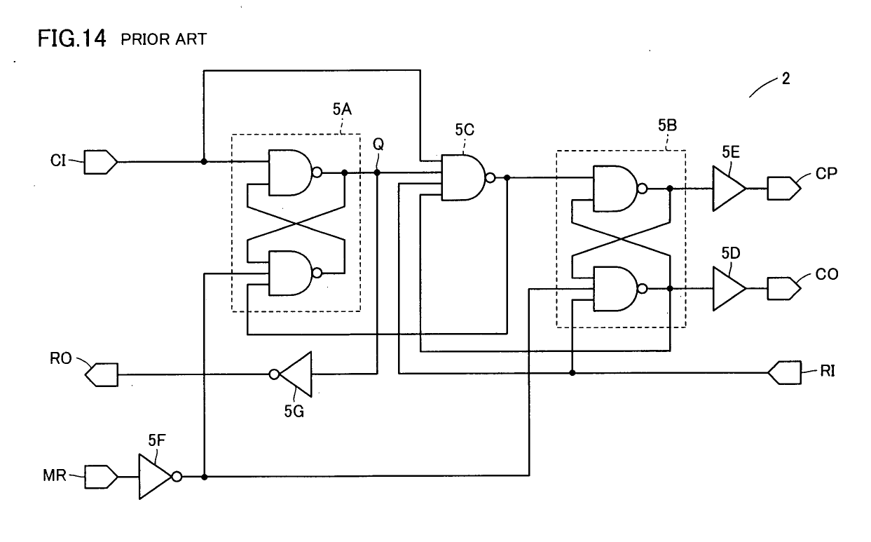

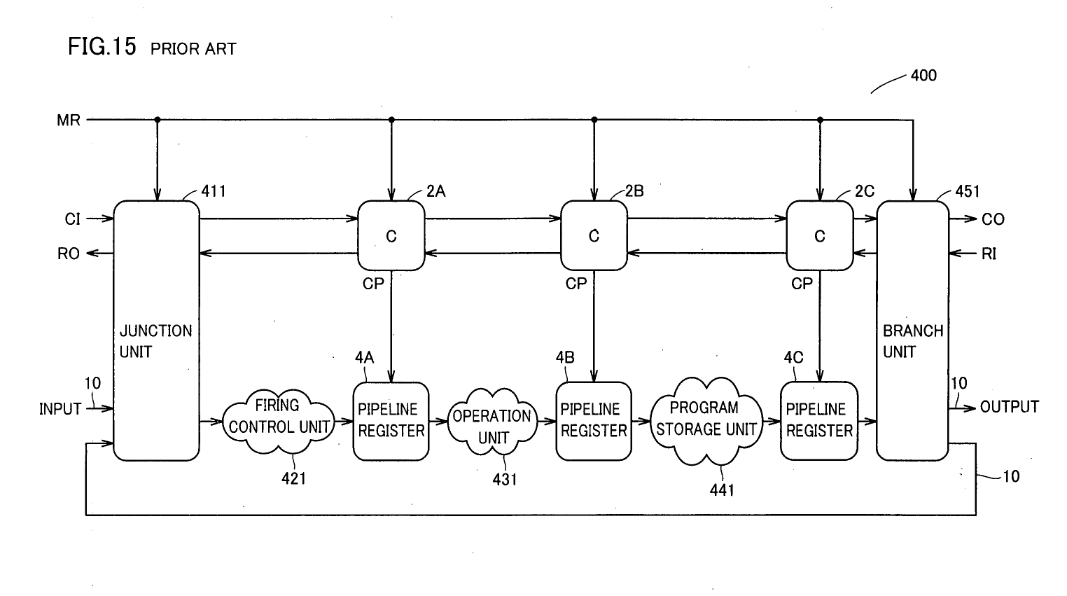

Comparing a data processor 50 applied to an embodiment of the present invention shown in FIG. 1 and a conventional data processor 30 shown in FIG. 13, they are different in that data processor 50 includes data transfer control units 25 shown in FIG. 2, in place of respective ones of data transfer control units 20 of data processor 30. Respective ones of a plurality of data transfer control units 25 of data processor 50 shown in FIG. 1 are distinguished as data transfer control units 25A and 25B. The rest of the configuration of data processing device 50 shown in FIG. 1 is similar to that shown in FIG. 13, and therefore, detailed description thereof is not repeated.

Referring to FIG. 2, data transfer control unit 25 includes a packet detection circuit (hereinafter referred to as P circuit) 1 using a control signal SU, a C element 2, a voltage control circuit 3 switching between an externally provided operation voltage signal VH and a suspension voltage signal VL to supply the same to a corresponding logic circuit, and a pipeline register 4. Data transfer control unit 25A includes a P circuit 1A and a voltage control circuit 3A, whereas data transfer control unit 25B includes a P circuit 1B and a voltage control circuit 3B. P circuits 1A and 1B have similar functions and configurations as P circuit 1, whereas voltage control circuits 3A and 3B have similar functions and configurations as voltage control circuit 3.

P circuit 1A is connected to the corresponding voltage control circuit 3A, and voltage control circuit 3A is connected to logic circuit 6A corresponding to data transfer control unit 25A. Similarly, P circuit 1B is connected to the corresponding voltage control circuit 3B, and voltage control circuit 3B is connected to logic circuit 6B corresponding to data transfer control unit 25B.

In FIG. 1, a control signal SU externally provided to data processor 50 is supplied to both P circuits 1A and 1B. Control signal SU is a control signal for subtracting the value of a packet counter 40 that is one type of registers, which will be discussed later, in P circuits 1A and 1B. Data packets 10 supplied from the preceding stage to data processor 50 are successively processed by logic circuits 6A and 6B while being transferred through the pipeline registers in the order of pipeline register 4A→4B→4C. To data processor 50, immediately after resetting by master reset signal MR, a control signal SU that is a pulse signal of a constant cycle is successively provided.

Voltage control circuits 3A and 3B supply either operation voltage signal VH or suspension voltage signal VL to logic circuits 6A and 6B, respectively, based on control signal XH from P circuits 1A and 1B, respectively. Specifically, respective ones select and supply operation voltage signal VH if control signal XH is at level “H”, and select and supply suspension voltage signal VL if it is at level “L”. Here, operation voltage signal VH indicates the voltage level required for logic circuits 6A and 6B to operate and to maintain the operation state, whereas suspension voltage signal VL indicates the voltage level required for logic circuits 6A and 6B to suspend and to maintain the suspended state. The relationship between those signal levels are VH>VL.

The suspension voltage level indicated by suspension voltage signal VL is the level that allows logic circuits 6A and 6B to quickly shift from the suspended state to operation state, when logic circuits 6A and 6B has been maintaining the suspended state and supplied with operation voltage signal VH.

Referring to FIG. 3, P circuit 1 includes a packet counter 40, a comparison value register 41, a comparator 42, a subtraction register 45, an addition register 46, a transfer request input terminal CCI and transfer request output terminal CCO. The count value of packet counter 40 is set to the initial value when master reset signal MR is externally provided, that is, it is reset. To packet counter 40, the maximum value and the minimum value (for example, the initial value) that can be counted are pre-set, and it is designed so that the count value does not exceed those values.

Transfer request input terminal CCI has similar function as transfer request input terminal CI, whereas transfer request output terminal CCO has similar function as transfer request output terminal CO. The configuration shown in FIG. 1 shows P circuits 1A and 1B being interposed among C elements 2A, 2B and 2C shown in FIG. 13, and therefore in FIG. 3, transfer request input terminal CCI receives SEND signal from C element 2A in the preceding stage, and transfer request output terminal CCO outputs ACK signal to transfer request input terminal CI of C element 2B in the next stage. P circuit 1 is triggered by SEND signal, whereby prescribed value M stored in addition register 46 in advance is added to the current count value in packet counter 40. Additionally, P circuit 1 is triggered by control signal SU supplied externally, whereby prescribed value N stored in subtraction register 45 in advance is subtracted from the current count value in packet counter 40. The current count value of packet counter 40 is provided to comparator 42. Comparator 42 compares prescribed comparison value CM stored in comparison value register 41 in advance and the current count value provided by packet counter 40. When the comparison result indicates that the current count value is greater than comparison value CM in comparison value register 41, comparator 42 outputs control signal XH at level “H”, and otherwise outputs control signal XH at level “L”.

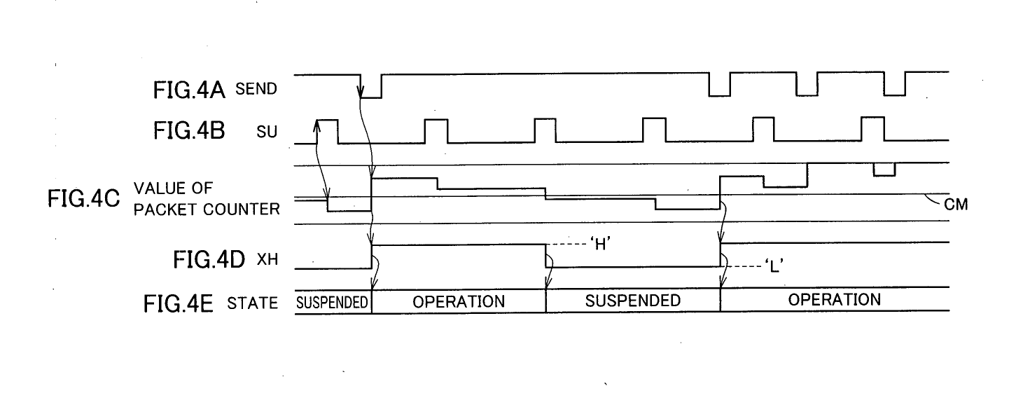

Referring to FIGS. 4A-4E, state transition between the suspended state and the operation state in data processor 50 shown in FIG. 1 is described. Control signal SU shown in FIG. 4B is simultaneously supplied as successive pulses to all of, or part of P circuits. As a result, as indicated by SEND signal shown in FIG. 4A, when data packet 10 is not input to data processor 50, that is, when clock pulse is not output to pipeline register 4 triggered by a transfer request indicated by a fall of SEND signal, after a certain period of time has passed since input of data packet 10 has stopped, by the effect of control signal SU, control signal XH output from all of P circuits attains the level “L” (see FIG. 4D) and data processor 50 enters the suspended state stopping data transfer (see FIG. 4E). That certain period of time is determined by pulse intervals (cycle) of control signal SU and prescribed value N for subtraction. The pulse intervals (cycle) can be variably set. For example, given that a pulse oscillator, which is not shown, is provided externally to data processor 50, which generates control signal SU and supplies it to data processor 50, the pulse intervals (cycle) of control signal SU is changed by adjusting the oscillation cycle through operation of an external switch or the like of the pulse oscillator.

When the output of clock pulse to pipeline register 4 triggered by a transfer request indicated by a fall of SEND signal shown in FIG. 4A is frequent, and therefore, data packets 10 are frequently supplied to logic circuit 6 through pipeline register 4, addition takes place in a number of times that provides a count value (addition result value) exceeding the count value (subtraction result value) of packet counter 40 under the effect of control signal SU. As a result, the count value in packet counter 40 exceeds comparison value CM in comparison value register 41 (see FIG. 4C), and consequently, control signal XH attains level “H” (see FIG. 4D), and data processor 50 transits from the suspended state to the operation state (see FIG. 4E). A prescribed value M that allows such state transition to take place is stored in addition register 46 in advance.

Accordingly, in FIG. 1, voltage control circuits 3A and 3B are controlled by control signal XH, and as a result, respective ones of logic circuits 6A and 6B receive either operation voltage signal VH or suspension voltage signal VL.

As described above, when data processor 50 receives data packets 10, increasing the frequency of the output of clock pulse triggered by SEND signal, and consequently when processing of data packets 10 is required, operation voltage signal VH is supplied to logic circuits 6A and 6B, and logic circuits 6A and 6B transit from the suspended state to operation state. On the other hand, when data processor 50 does not receive data packets 10 and therefore data processing is not necessary (when clock pulse is not output), suspension voltage signal VL is supplied to logic circuits 6A and 6B, and logic circuits 6A and 6B transit from the operation state to the suspended state.

Prescribed values M and N and comparison value CM shown in FIG. 3 can each be set variably, and preferably they have the following relationship. Namely, at least M>N relationship must be satisfied. This relationship is applicable given that data processor 50 receives data packets 10 discretely and in certain numbers, and with a certain period of time without reception thereafter, it again receives a group of data packets 10. This is described referring to FIGS. 2 and 3.

At the arrival of the first data packet 10 to data transfer control unit 25, in order to supply operation voltage signal VH to logic circuit 6A (6B) as soon as possible so that it can transit from the suspended state to the operation state, prescribed value M must be a great value. Additionally, supply of operation voltage signal VH to logic circuit 6A (6B) must be maintained for data processing for a certain period of time after data processor 50 receives the last data packet 10, and therefore, subtraction using prescribed value N continues for that period of time, then transition from the operation state to the suspended state takes place. Since data transfer control unit 25 does not have a function to determine whether a data packet 10 is the last one to be input or not, an operation for retaining for a while the level of the voltage supplied to logic circuit 6A (6B) to the level with which the operation state can be maintained. FIGS. 4A-4E show such state transition.

It is noted that, variable setting of respective ones of prescribed values N and M can be attained as follows, for example. A mini switch is provided to subtraction register 45, addition register 46 and comparison value register 41 shown in FIG. 3, so that respective ones of prescribed values N and M and comparison value CM stored in each register can variably be set.

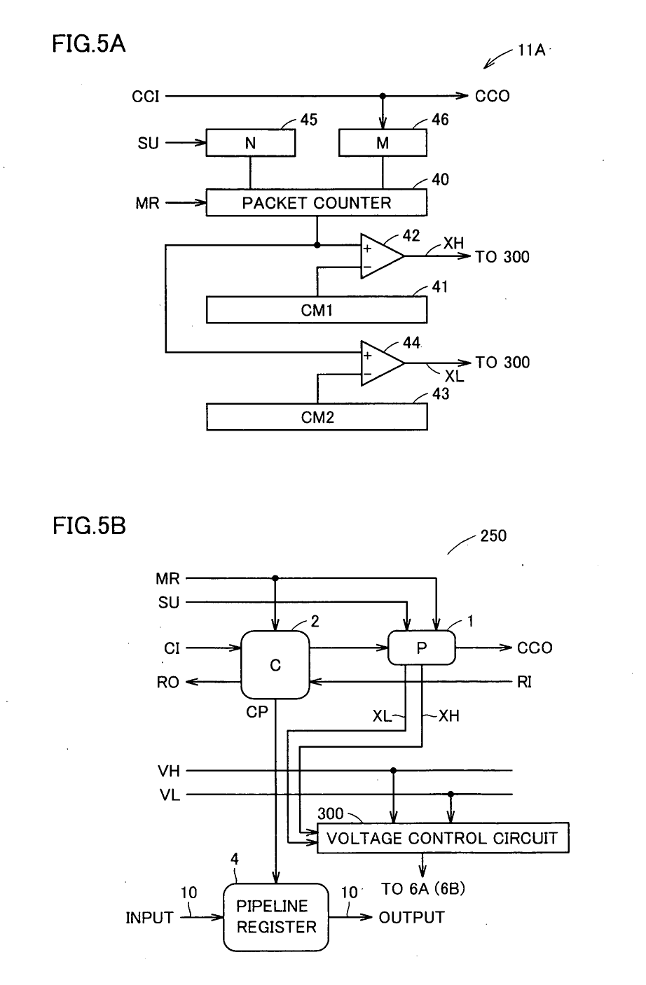

While in the present embodiment control signal XH output from P circuit 1 shown in FIG. 3 takes on two values of levels “H” and “L”, it may take on three or more values. For example, as shown in FIG. 5A, the configuration of P circuit 11A is also possible. In addition to the configuration of P circuit 1 shown in FIG. 3, P circuit 11A includes a comparison value register 43 storing a comparison value CM2 and a comparator 44, and outputs control signals XH and XL, thereby attaining three values of the level of control signal provided to corresponding voltage control circuit 3. In this case, the voltage level that can be supplied to logic circuit 6A (6B) has three types. In FIG. 5A, comparison value CM1 is stored in comparison value register 41. Comparator 42 compares the count value of packet counter 40 and comparison value CM 1 of comparison value register 41 and outputs control signal XH indicative of the comparison result. Comparator 44 compares the count value of packet counter 40 and comparison value CM2 of comparison value register 43, and outputs control signal XL indicative of the comparison result. Comparison values CM1 and CM2 can be set variably. Data transfer control unit 250 shown in FIG. 5B has a configuration corresponding to P circuit 11A shown in FIG. 5A.

In FIG. 5B, a combination signal (XL, XH) of control signals XL and XH is provided to corresponding voltage control circuit 300. It is assumed that comparison values CM1 and CM2 are different values and satisfy CM1>CM2, and therefore combination signal (XL, XH) may take on the values of (1, 1), (1, 0) and (0, 0). As a result, corresponding logic circuit 6A (6B) may also be in states of three types. For example, given that corresponding logic circuit 6A (6B) may have three states of a fast operation state, a slow operation state and a suspended state, then the values of combination signal (XL, XH) for attaining the fast operation state, the slow operation state and the suspended state can be assigned the values of (1, 1), (1, 0) and (0, 0), respectively. Voltage control circuit 300 is designed to generate a voltage control signal indicative of voltage levels corresponding to respective ones of the three states based on the supplied operation voltage signal VH and suspension voltage signal VL and to output the same to corresponding logic circuit 6A (6B).

An LSI such as data transfer control unit 250 changes its operation speed depending on the voltage level being supplied. Therefore, when data packets 10 provided to data transfer control unit 250 are not many, that is, when data packets 10 being provided can be processed even at slow operation speed, logic circuit 6A (6B) is allowed to transit to slow operation state with the configuration of FIGS. 5A and 5B. Thereafter, if data packets 10 provided to data transfer control unit 250 increase in the number and the fast operation is needed, then logic circuit 6A (6B) is allowed to transit from the slow operation state to the fast operation state. As a result, with data transfer control unit 250 and data processor 50 including the same, level adjustment of the supplied voltage in accordance with the amount of data packets 10 being transferred can be attained, whereby excessive power consumption and power shortage are prevented.

With the present embodiment, as the cycle of control signal SU, comparison values CM, CM1 and CM2, addition value M and subtraction value N can be changed arbitrarily, changing the timing of state transition shown in FIG. 4E can easily be attained.

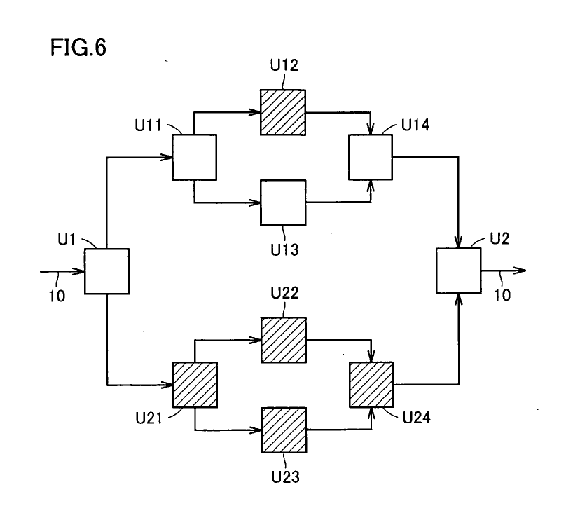

The large scale, processing system shown in FIG. 6 includes data processors U1, U2, U11-U14 and U21-U24. Respective ones of the data processors have similar configuration and function as above-described data processor 50. It is assumed that data packet 10 is provided to the processing system shown in FIG. 6, and received by data processor U1. The received data packet 10 is processed at data processor U1, and thereafter processed while being transferred through data processors in the order of data processor U11→U13→U14→U2, to be output from the processing system. In this case, as data packet 10 is not provided to data processors U12, U21, U22, U23, and U24 shown hatched in FIG. 6, all logic circuits 6 in those processors are supplied with suspension voltage signal VL, whereby those data processors enter the suspended state. Thereafter, when data packet 10 is input to data processors U12, U21, U22, U23, and U24, as the voltage signal provided to all logic circuits 6 in those processors is switched from suspension voltage signal VL to operation voltage signal VH, logic circuits 6 transit from suspended state to operation state, attaining the state for receiving and processing data packet 10.

Another Embodiment

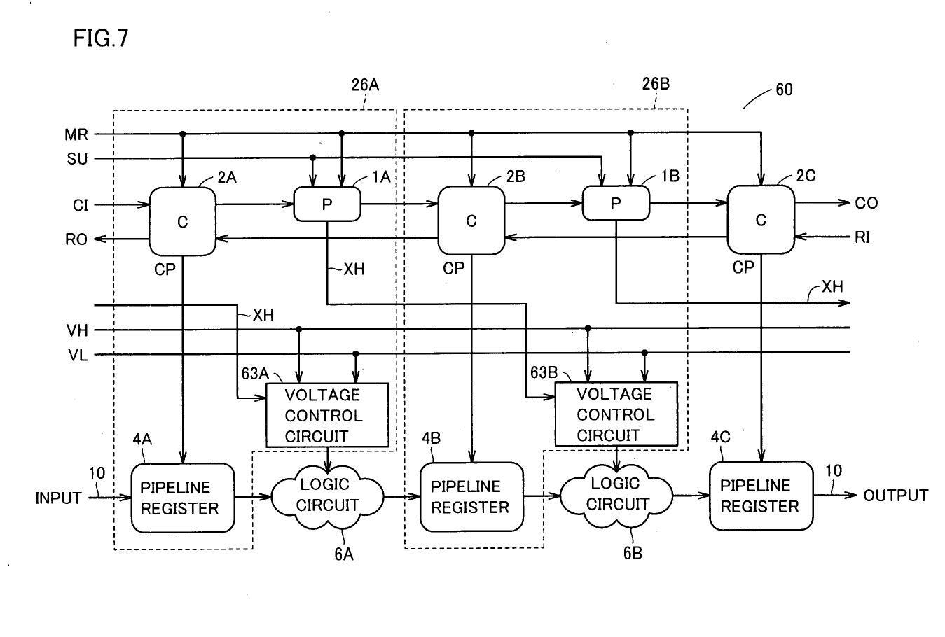

A data processor 60 according to another embodiment shown in FIG. 7 includes data transfer control units 26A and 26B, in place of data transfer control units 25A and 25B shown in FIG. 1. The rest of the configuration is similar to that of data processor 50 shown in FIG. 1. Data transfer control units 26A and 26B have similar functions and configurations as those of data transfer control units 25A and 25B, except that, in data transfer control units 26A and 26B, voltage control circuits 63A and 63B are supplied with control signal XH output from P circuit 1 of the data transfer control unit of the precedent stage.

In data processor 60 shown in FIG. 7, a plurality stages of pipelines including data transfer control units 26A and 26B are connected in series, each data transfer control unit can determine in advance whether or not it is to receive the next data packet 10 or not, since voltage control circuit 63A (63B) in its own stage is provided with the level of control signal XH indicative of the state of P circuit 1 of the data transfer control unit in the preceding stage. By the time the next data packet 10 is input to its own stage, logic circuit 6A (6B) in the suspended state must transit to the operation state. In this case, as control signal XH at level “H” is provided from the preceding stage to voltage control circuit 63A (63B) in its own stage, that is, as input of data packet 10 can be detected in advance, a precharge time necessary for logic circuit 6A (6B) to transit from the suspended state to the operation state can be ensured in advance. In other words, a waiting time until logic circuit 6A (6B) transits from the suspended state to the operation state can be reduced, and therefore, when all the data transfer control units connected in a plurality of stages including data transfer control units 26A and 26B receive data packet 10, that data packet 10 can quickly be processed at logic circuit 6A (6B). As a result, with data processor 60, the above-described reduction of power consumption as well as an improvement in the speed of a series of operations of transferring data packet 10 while processing the same can be achieved.

Still Another Embodiment

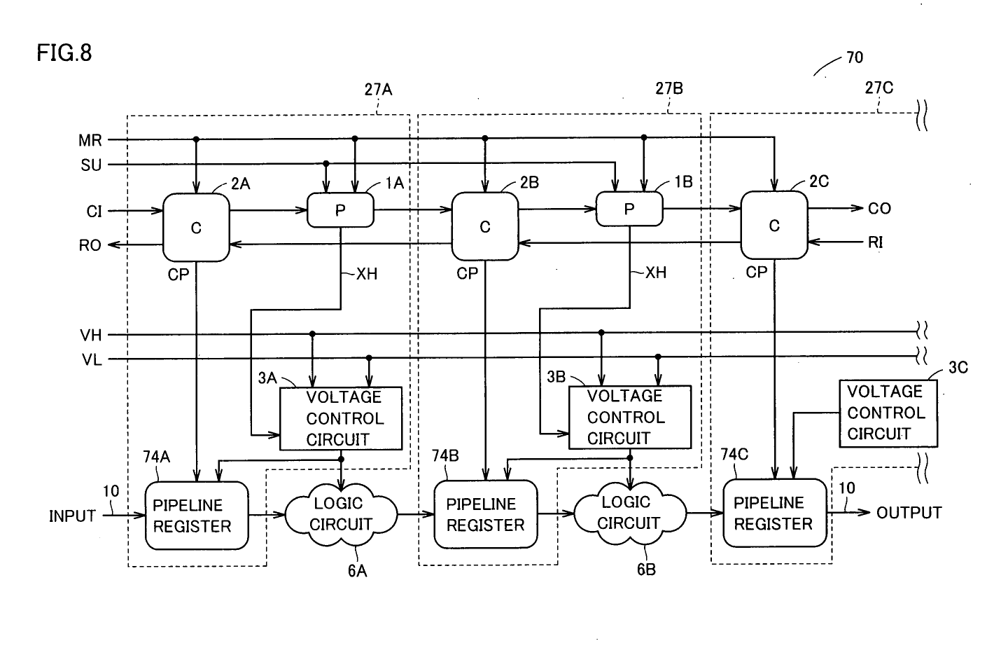

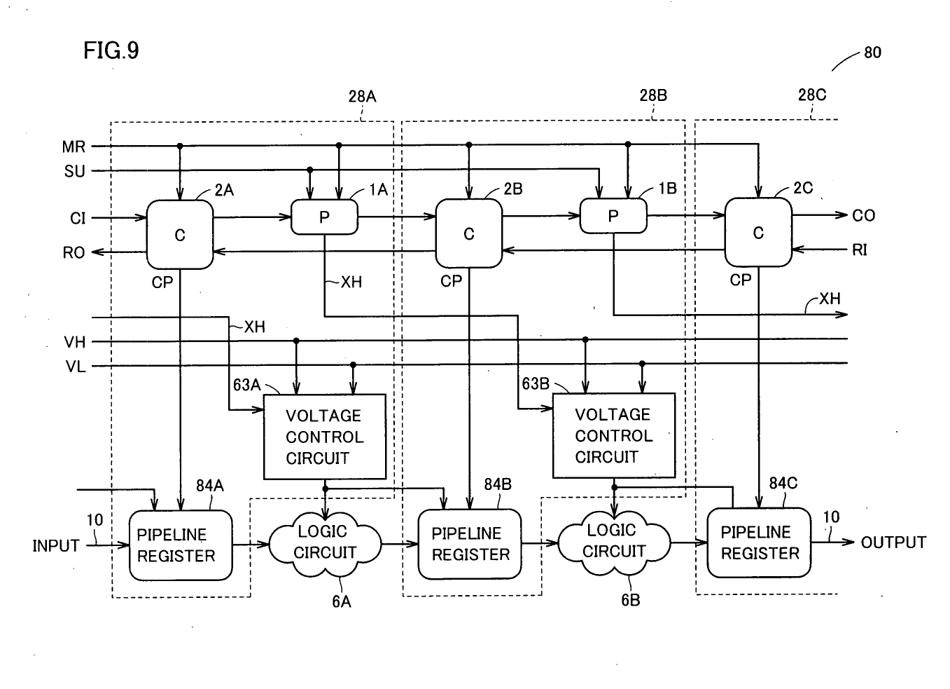

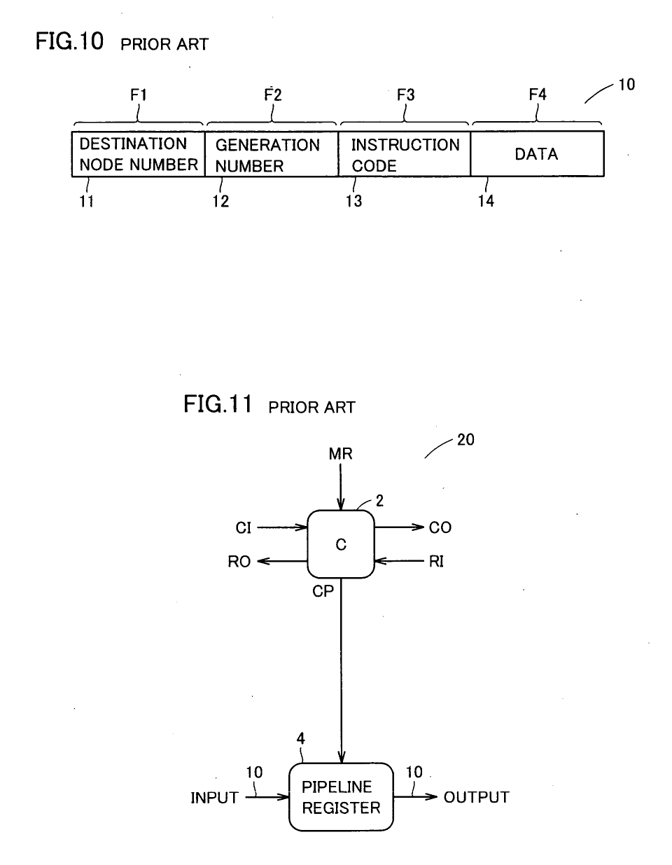

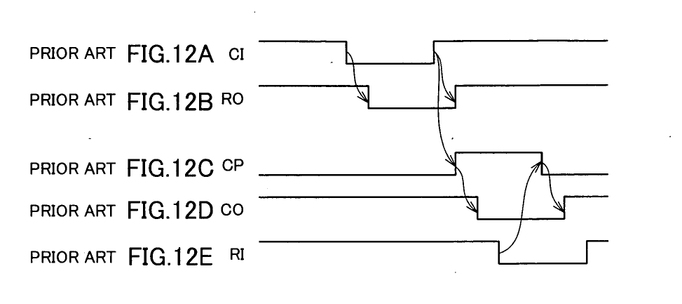

FIGS. 8 and 9 show data processors 70 and 80 according to still another embodiment.

Data processor 70 shown in FIG. 8 includes data transfer control units 27A and 27B in place of data transfer control units 25A and 25B shown in FIG. 1. The rest of the configuration is similar to that of data processor 50 shown in FIG. 1. Data transfer control units 27A, 27B and 27C have the feature of supplying suspension voltage signal VL or operation voltage signal VH not only to the logic circuits in their own stage (such as logic circuits 6A and 6B) but also to pipeline registers 74A, 74B and 74C in their own stage. Except for this feature, they have similar functions and configurations as those of data transfer control units 25A and 25B. Respective ones of pipeline registers 74A, 74B and 74C operate similarly as pipeline register 4A (4B), and the operation is controlled based on suspension voltage signal VL or operation voltage signal VH being provided.

Here, operation voltage signal VH indicates the voltage level necessary for logic circuits 6A and 6B and pipeline registers 74A, 74B and 74C to operate and to maintain the operation state, whereas suspension voltage signal VL indicates the voltage level necessary for logic circuits 6A and 6B and pipeline registers 74A, 74B and 74C to suspend and to maintain the suspended state. The relationship of the levels is VH>VL. The level of the suspension voltage indicated by suspension voltage signal VL is the level that allows logic circuit 6A (6B) and pipeline register 74A (74B, 74C) to quickly transit from the suspended state to the operation state, if they are supplied with operation voltage signal VH when they have been in the suspended state.. The operation state of pipeline register 74A (74B, 74C) refers to the state where it can receive, retain and output data packet 10 being provided. The suspended state refers to the state where it cannot receive, retain and output data packet 10 being provided.

With data processor 70 shown in FIG. 8, as not only the supply voltage level of logic circuit 6A (6B) but also the supply voltage level of pipeline register 74A (74B, 74C) are controlled by voltage control circuit 3A (3B, 3C) in accordance with the amount of data packet 10 to be transferred, further reduction of power consumption can be achieved.

Referring to FIG. 8, while the voltage level supplied to a pipeline register is controlled by the voltage control circuit of the data transfer control unit of that pipeline register, the voltage level supplied to the pipeline register may be, as shown in FIG. 9, controlled by the voltage control circuit of the data transfer control unit in the preceding stage.

Data processor 80 shown in FIG. 9 includes data transfer control units 28A, 28B and 28C having similar functions and configurations. In FIG. 9, data transfer control units 26A and 26B shown in FIG. 7 are replaced by data transfer control units 28A and 28B, and the rest of the configuration is similar to that shown in FIG. 7. Data processor 80 has such a feature that in respective ones of data transfer control units, suspension voltage signal VL or operation voltage signal VH is supplied from the voltage control circuit of the data transfer control unit in the preceding stage to the pipeline register. For example, in data transfer control unit 28B, from voltage control circuit 63A of data transfer control unit 28A of the precedent stage, suspension voltage signal VL or operation voltage signal VH is supplied to pipeline register 84B. Except. for this feature, respective ones of data transfer control units 28A, 28B and 28C have similar functions and configurations as data transfer control unit 26A (26B) shown in FIG. 7.

In FIG. 9, focusing on data transfer control units 28B and 28C, for example, operation voltage signal VH output from voltage control circuit 63A (63B) indicates the voltage level necessary for logic circuit 6A (6B) of the data transfer control unit of voltage control circuit 63A (63B) and pipeline register 84B (84C) of the data transfer control unit in the next stage to operate and to maintain the operation state, whereas suspension voltage signal VL indicates the voltage level necessary for logic circuit 6A (6B) of the data transfer control unit of voltage control circuit 63A (63B) and pipeline register 84B (84C) of the data transfer control unit in the next stage to suspend and to maintain the suspended state, the relationship of the levels being VH>VL. The level of the suspension voltage indicated by suspension voltage signal VL is the level that allows logic circuit 6A (6B) and pipeline register 84B (84C) to quickly transit from the suspended state to operation state, if they are supplied with operation voltage signal VH when they have been in the suspended state. This description is similarly applicable to data transfer control unit 28A. The operation state of pipeline registers 84A, 84B and 84C refers to the state where they can receive, retain and output data packet 10 being provided. The suspended state refers to the state where they cannot receive, retain and output data packet 10 being provided.

Between FIGS. 8 and 9, the level of operation voltage signal VH supplied from the voltage control circuit to the logic circuit and the pipeline register may be the same or different. Similarly, the level of suspension voltage signal VL may be the same or different.

In data processor 80, similarly to data processor 60, a plurality of stages of pipelines including data transfer control units 28A and 28B are connected in series, each data transfer control unit can determine in advance whether or not it is to receive the next data packet 10, by detecting the level of control signal XH indicative of the state of P circuit 1 of the data transfer control unit in the preceding stage.

For example, in data transfer control unit 28B, when it is determined that data packet 10 is to be provided to data transfer control unit 28B based on an input of control signal XH at level “H” indicating the state of P circuit 1 of data transfer control unit 28A in the preceding stage to voltage control circuit 63B while pipeline register 84B and logic circuit 6B are in the suspended state, that is, when logic circuit 6B is to transit to the operation state, it is necessary to allow pipeline register 84B having been in the suspended state to transit to the operation state prior to logic circuit 6B, before data transfer control unit 28B receives next data packet 10 from data transfer control unit 28A. In order to meet the requirement, pipeline register 84B is supplied with operation voltage signal VH from voltage control circuit 63A of data transfer control unit 28A in the preceding stage. Accordingly, a precharge time necessary for pipeline register 84B to transit from the suspended state to the operation state can be ensured. Specifically, a waiting time for pipeline register 84B having been in the suspended state to transit to the operation state when data packet 10 is to be transferred from data transfer control unit 28A to data transfer control unit 28B can be reduced, and therefore, on reception of data packet 10, every data transfer units connected in a plurality of stages including data transfer control units 28A, 28B and 28C can and quickly process that data packet 10 with the corresponding logic circuit. As a result, with data processor 80, the above-described reduction of power consumption as well as an improvement in the speed of a series of operations of transferring data packet 10 while processing the same can be achieved.

According to the above-described data processors 50, 60, 70 and 80, supply voltage level can be adjusted autonomously and for each data transfer control unit (pipeline stage), without external. control such as a program.

Additionally, according to another embodiment and still another embodiment, a precharge time necessary for logic circuit 6A (6B) to transit from the suspended state to the operation state can be ensured in advance.

Respective ones of data processors 50, 60, 70 and 80 may be mounted on a data-driven type information processor. In this case, to logic circuit 6 of each data transfer control unit, firing control unit 421, operation unit 431 and program storage unit 441 are applied.

Although the present invention has been described and illustrated in detail, it is clearly understood that the same is by way of illustration and example only and is not to be taken by way of limitation, the spirit and scope of the present invention being limited only by the terms of the appended claims.

1. A data processor, comprising:
transfer control units serially connected in a plurality of stages; and
processing units respectively connected to said plurality of stages of said transfer control units, each receiving data output from said transfer control unit being connected, processing the received data, and outputting the processed data to said transfer control unit in a next stage; wherein
a speed of said processing by said processing unit is changed in accordance with a level of a voltage supplied to said processing unit, and wherein
said transfer control units each include
a self-synchronous type transfer control unit receiving a request pulse for data transfer provided from a preceding stage and transferring said request pulse to a next stage based on a request signal for data transfer and a permission signal for data transfer,
a holding register receiving, holding and outputting data requested to be transferred in response to every reception of said request pulse by said self-synchronous type transfer control unit, and
a voltage control unit determining frequency of data supply to said processing unit being connected, and controlling the level of the voltage supplied to said processing unit in accordance with the determined frequency.

2. The data processor according to claim 1, wherein
said frequency determined by said voltage control unit indicates frequency of reception of said request pulse by said transfer control unit including the voltage control unit.

3. The data processor according to claim 2, wherein
an operation state of said holding register is changed in accordance with a level of a voltage being supplied, and
said voltage control unit determines frequency of data supply to said processing unit being connected, and controls the level of the voltage supplied to said holding register of said transfer control unit including the voltage control unit in accordance with the determined frequency.

4. The data processor according to claim 1, wherein
said frequency determined by said voltage control unit indicates frequency of reception of said request pulse by said transfer control unit in a preceding stage relative to said transfer control unit including the voltage control unit.

5. The data processor according to claim 4, wherein
an operation state of said holding register is changed in accordance with a level of a voltage being supplied, and
said voltage control unit determines frequency of data supply to said processing unit being connected, and controls the level of the voltage supplied to said holding register of said transfer control unit in a next stage relative to said transfer control unit including the voltage control unit in accordance with the determined frequency.

6. The data processor according to claim 1, wherein
said voltage control unit includes
a counter unit adding a prescribed addition value to a current count value in response to every reception of said request pulse, and subtracting a prescribed subtraction value from said current count value in a prescribed cycle during a period without reception of said request pulse, and
a voltage select unit selectively determining the level of the voltage supplied to said processing unit based on said current count value of said counter unit.

7. The data processor according to claim 6, wherein
said voltage select unit selectively determines the level of the voltage supplied to said processing unit based on said current count value of said counter unit of said transfer control unit including the voltage control unit.

8. The data processor according to claim 6, wherein
said voltage select unit selectively determines the level of the voltage supplied to said processing unit based on said current count value of said counter unit of said transfer control unit in a preceding stage relative to said transfer control unit including the voltage control unit.

9. The data processor according to claim 6, wherein
said voltage select unit has a compare unit comparing said current count value and a prescribed value, and determines the level of the voltage supplied to said processing unit out of two types of levels based on a comparison result of said compare unit.

10. The data processor according to claim 9, wherein
said prescribed value is variably set.

11. The data processor according to claim 6, wherein
said voltage select unit has a plurality of compare units comparing said current count value and respective ones of a plurality of different prescribed values, and determines the level of the voltage supplied to said processing unit out of at least three types of levels based on respective comparison results of said plurality of compare units.

12. The data processor according to claim 11, wherein
said prescribed values are variably set.

13. The data processor according to claim 6, wherein
said prescribed cycle is variably set.

14. The data processor according to claim 6, wherein
said prescribed addition value or said prescribed subtraction value is variably set.

15. The data processor according to claim 1, wherein
an operation state of said holding register is changed in accordance with a level of a voltage being supplied, and
said voltage control unit determines frequency of data supply to said processing unit being connected, and controls the level of the voltage supplied to said holding register of said transfer control unit including the voltage control unit in accordance with the determined frequency.

16. The data processor according to claim 1, wherein
an operation state of said holding register is changed in accordance with a level of a voltage being supplied, and
said voltage control unit determines frequency of data supply to said processing unit being connected, and controls the level of the voltage supplied to said holding register of said transfer control unit in a next stage relative to said transfer control unit including the voltage control unit in accordance with the determined frequency.
